(19) United States
(12) Patent Application Publication
(10) Pub. No.: US 2008/0266220 A1
(43) Pub. Date: Oct. 30, 2008

(54) Scan driver

(75) Inventors: Chien-Kuo Wang, Jhubei City (TW); Hsin-Yeh Wu, Kaohsiung City (TW); Shao-Ping Hung, Taipei City (TW); Chin-Chieh Chao, Hsinchu City (TW)

Correspondence Address: RABIN & Berdo, PC, 1101 14TH STREET, NW, SUITE 500, WASHINGTON, DC, 20005, US

(73) Assignee: Raydium Semiconductor Corporation, Hsinchu (TW)

(21) Appl. No.: 12/078,607

(22) Filed: Apr. 2, 2008

(30) Foreign Application Priority Data
Apr. 24, 2007 (TW) 096114498

(51) Int. Cl. G09G 3/36

(52) U.S. Cl. 345/87

(57) ABSTRACT

A scan driver for a liquid crystal display (LCD) includes first and second address logic units, first and second level shifters and a decoder. The first address logic unit enables an i^{th} first address signal among N first address signals during a K^{th} clock period according to a control signal, wherein the number i is equal to a remainder of K/N. The second address logic unit enables a j^{th} second address signal among M second address signals during the K^{th} clock period according to the control signal, wherein the number j is equal to a quotient of K/N plus 1. The first and second level shifters respectively increase swings of the first and second address signals. When the i^{th} first address signal and the j^{th} second address signal are enabled, the decoder enables a (j−1)×N+i)^{th} scan signal among M×N scan signals.

This application claims the benefit of Taiwan application Serial No. 96114498, filed Apr. 24, 2007, the subject matter of which is incorporated herein by reference.

### BACKGROUND OF THE INVENTION

1. Field of the Invention

The invention relates in general to a scan driver, and more particularly to a scan driver for determining a scan signal according to two sets of address signals.

2. Description of the Related Art

FIG. 1 (Prior Art) shows the architecture of a conventional scan driver 100 having 256 scan signals. Referring to FIG. 1, the scan driver 100 includes a shift register 110, a controller 120, a level shifter 130 and an output buffer unit 140. The shift register 110 receives an initial signal DIO and a clock signal CPV. When the initial signal DIO becomes enabled, the shift register 110 starts to sequentially enable address signals A(1) to A(256) during 256 clock periods according to the clock signal CPV. The controller 120 receives the address signals A(1) to A(256) and further determines whether to compulsively enable all the address signals A(1) to A(256) or not according to a control signal XON. The level shifter 130 receives the address signals A(1) to A(256) and increases swings of the address signals A(1) to A(256). The output buffer unit 140 receives and buffers the address signals A(1) to A(256) with the increased swings, and then outputs scan signals G(1) to G(256) corresponding to the address signals A(1) to A(256).

FIG. 2 (Prior Art) is a circuit diagram showing a level shift circuit 131 and an output buffer circuit 141 corresponding to each address signal in the level shifter 130 and the output buffer unit 140. The scan driver 100 outputs 256 address signals, so 256 level shift circuits 131 and 256 output buffer circuits 141 of FIG. 2 are needed. In the example of FIG. 2, the level shift circuit 131 receives the address signal A(1), and the buffer circuit 141 outputs the scan signal G(1) corresponding to the address signal. The address signal A(1) includes differential signals A1N and A1P.

Because the dimension ratios between transistors in the level shift circuit 131 have to be considered, the area occupied by the level shift circuit 131 is very large. Consequently, the cost of the scan driver is increased.

### SUMMARY OF THE INVENTION

The invention is directed to a scan driver for respectively enabling one of M×N scan signals by respectively enabling one of N first address signals and one of M second address signals during M×N clock periods.

According to the present invention, a scan driver for a liquid crystal display (LCD) is provided. The scan driver includes a first address logic unit, a second address logic unit, a first level shifter, a second level shifter and a decoder. The first address logic unit enables an i^{th} first address signal among N first address signals during a K^{th} clock period according to a first control signal, wherein the number i is equal to a remainder of K/N and is equal to N when K is a multiple of N. The second address logic unit enables a j^{th} second address signal among M second address signals during the K^{th} clock period according to the first control signal, wherein the number j is equal to a quotient of K/N plug 1. The first level shifter increases swings of the first address signals. The second level shifter increases swings of the second address signals. The decoder enables a (j−1)×N+i)^{th} scan signal among M×N scan signals when the i^{th} first address signal is enabled and the j^{th} second address signal is enabled. Each of K, M and N is a positive-integer, the number i is a positive integer smaller than or equal to N, and j is a positive integer smaller than or equal to M.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows the architecture of a conventional scan driver having 256 scan signals.

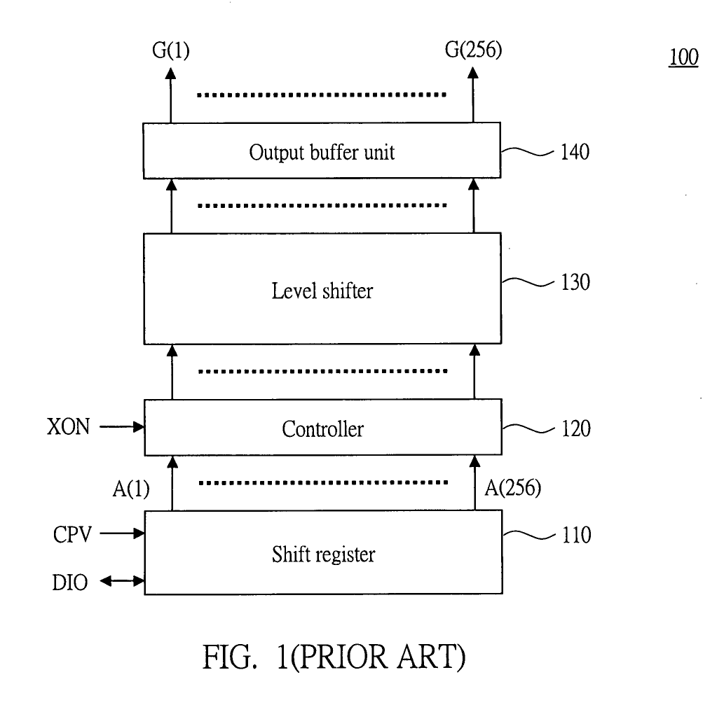

FIG. 2 (Prior Art) is a circuit diagram showing a level shift circuit and an output buffer circuit corresponding to each address signal in a level shifter and an output buffer unit.

FIG. 3 shows the architecture of a scan driver according to an embodiment of the invention.

FIG. 4 is a timing chart showing first address signals, second address signals, a control signal and a clock signal of the scan driver according to the embodiment of the invention.

FIG. 5 is a circuit diagram showing a decoding circuit and an output buffer circuit in a decoder and an output buffer unit of the scan driver according to the embodiment of the invention.

FIG. 6 is a circuit diagram showing another NOR decoding circuit.

FIG. 7 shows a scan driver according to another embodiment of the invention.

FIG. 8 shows the architecture of a decoding circuit in a decoder of the scan driver of FIG. 7.

FIG. 9 is a circuit diagram showing a buffer circuit in a buffer unit of FIG. 7 and the decoding circuit of FIG. 8.

### DETAILED DESCRIPTION OF THE INVENTION

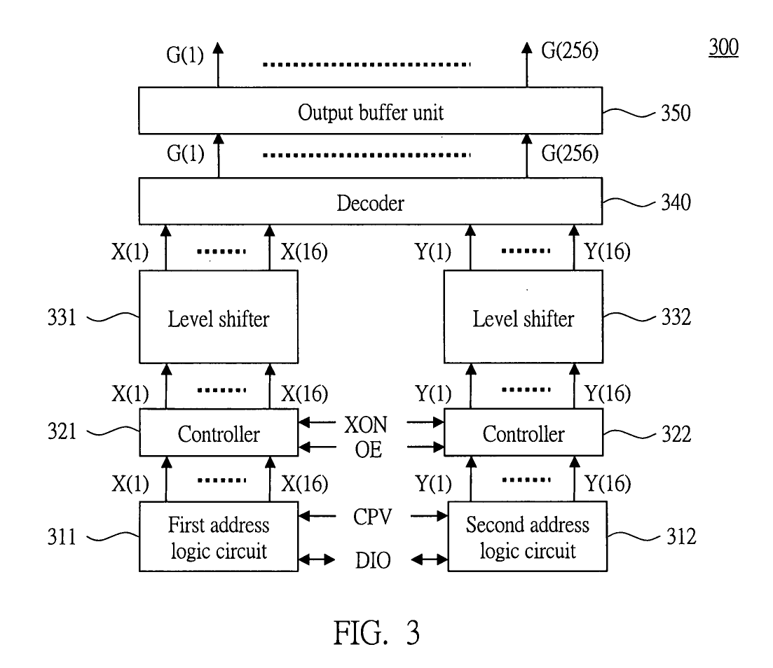

FIG. 3 shows the architecture of a scan driver 300 according to an embodiment of the invention. Referring to FIG. 3, the scan driver 300 applied to a liquid crystal display (LCD) includes a first address logic unit 311, a second address logic unit 312, level shifters 331 and 332 and a decoder 340.

The first address logic unit 311 receives a clock signal CPV and a control signal DIO. The first address logic unit 311 enables an i^{th} first address signal X(i) among N first address signals during a K^{th} clock period T(K) according to the control signal DIO, wherein the number i is a positive integer smaller than or equal to N and is equal to a remainder of K/N. When K is a multiple of N, the number i is equal to N. In this embodiment of the invention, N is equal to 16, for example.

The second address logic unit 312 enables a j^{th} second address signal Y(j) among M second address signals during the K^{th} clock period T(K) according to the control signal DIO, wherein the number j is a positive integer smaller than or equal to M and is equal to a quotient of K/N plus 1. In this embodiment of the invention, M is also equal to 16, for example.

The level shifter 331 increases swings of first address signals X(1) to X(16). The level shifter 332 increases swings of second address signals Y(1) to Y(16).

When the first address signal X(i) is enabled and the second address signal Y(j) is enabled, the decoder 340 enables a (j−1)×N+i)^{th} scan signal among M×N scan signals, wherein K is a positive integer smaller than or equal to M×N. In this embodiment of the invention, K is smaller than or equal to 256.

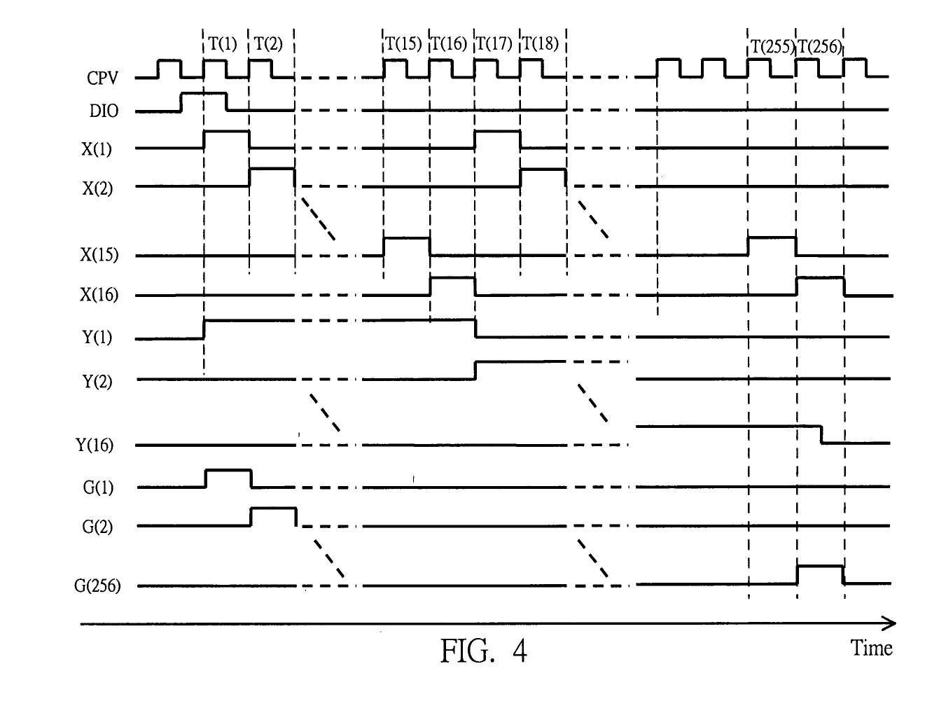

FIG. 4 is a timing chart showing the first address signals X(1) to X(16), the second address signals Y(1) to Y(16), the control signal DIO and the clock signal CPV of the scan driver 300 according to the embodiment of the invention. Operations of the scan driver 300 according to the embodiment of the invention will be described with reference to FIGS. 3 and 4.

In the embodiment of the invention, the control signal DIO is a initial signal. When the control signal DIO becomes enabled, the first address logic unit 311 enables the 1^{st} first address signal X(1) during a 1^{st} clock period T(1), and the second address logic unit 312 enables the second address signal Y(1). The swings of the first address signal X(1) and the second address signal Y(1) are respectively increased by the level shifters 331 and 332. Then, the decoder 340 enables a 1^{st} scan signal G(1) according to the enabled first address signal X(1) and second address signal Y(1).

Thereafter, the first address logic unit 311 respectively and sequentially enables the first address signals X(2) to X(16) during the 2^{nd} to 16^{th} clock periods T(2) to T(16), and the second address logic unit 312 still enables the second address signal Y(1). The decoder 340 respectively outputs the scan signals G(2) to G(16) according to the enabled first address signals X(2) to X(16) and the enabled second address signal Y(1).

During the 1^{st} to 16^{th} clock periods, the 16 first address signals X(1) to X(16) have been enabled. Thereafter, the second address logic circuit 312 enables the second address signal Y(2), and the first address logic circuit 311 further respectively and sequentially enables the first address signals X(1) to X(16) during the 17^{th} to 32^{nd} clock periods. The decoder 340 respectively enables the scan signals G(17) to G(32) according to the enabled first address signals X(1) to X(16) and the enabled second address signal Y(2).

Thereafter, the first and second address logic circuits enable the first and second address signals according to the manner mentioned hereinabove. During the 241^{st} to 256^{th} clock periods T(241) to T(256), the second address logic circuit 312 enables the second address signal Y(16), and the first address logic circuit 311 further respectively and sequentially enables the first address signals X(1) to X(16). The decoder 340 sequentially enables the scan signals G(241) to G(256).

The scan driver according to the embodiment of the invention enables 256 scan signals by respectively enabling 16 first address signals and 16 second address signals during 256 clock periods.

The scan driver 300 of this embodiment may further include controllers 321 and 322. The controller 321 receives the first address signals X(1) to X(16) transferred from the first address logic circuit 311. The controller 321 further determines whether to enable the first address signals X(1) to X(16) or not according to the control signal XON and outputs the first address signals X(1) to X(16) to the level shifter 331.

The controller 322 receives the second address signals Y(1) to Y(16) transferred from the second address logic circuit 312. The controller 322 further determines whether to enable the second address signals Y(1) to Y(16) or not according to the control signal XON, and outputs the second address signals Y(1) to Y(16) to the level shifter 332.

In this embodiment of the invention, when the control signal XON is enabled, the controller 321 compulsively enables all the first address signals X(1) to X(16), and the controller 322 compulsively enables all the second address signals Y(1) to Y(16) so that all the scan signals G(1) to G(256) are enabled. When the control signal XON is not enabled, the controllers 321 and 322 do not change the originally enabled or disabled states of the first address signals X(1) to X(16) and those of the second address signals Y(1) to Y(16), but directly transfer the originally enabled or disabled states thereof to the level shifters 331 and 332, respectively.

When another control signal OE is enabled, the controller 321 compulsively disables all the first address signals X(1) to X(16) and the controller 322 compulsively disables all the second address signals Y(1) to Y(16) so that all the scan signals G(1) to G(256) are disabled. When the control signal OE is disabled, the controllers 321 and 322 do not change the originally enabled or disabled states of the first address signals X(1) to X(16) and those of the second address signals Y(1) to Y(16), but directly transfer the originally enabled or disabled states thereof to the level shifters 331 and 332.

The scan driver 300 according to the embodiment of the invention may further include an output buffer unit 350 for receiving and buffering the scan signals G(1) to G(256) and then outputting the buffered scan signals G(1) to G(256).

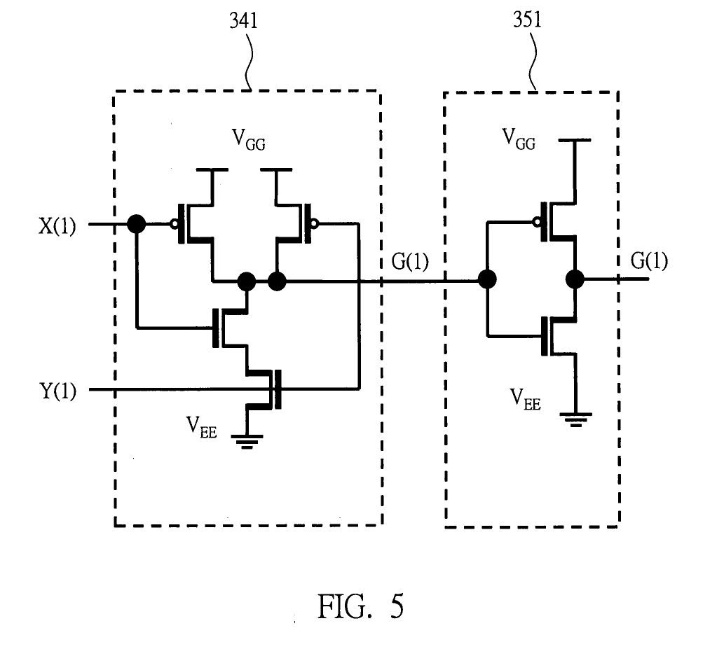

FIG. 5 is a circuit diagram showing a decoding circuit 341 and an output buffer circuit 351 in the decoder 340 and the output buffer unit 350 of the scan driver 300 according to the embodiment of the invention. The decoding circuit 341 is a NAND decoding circuit. In this embodiment of the invention, the decoder 340 and the output buffer unit 350 respectively have 256 decoding circuits and 256 output buffer circuits. Each decoding circuit receives one of the 16 first address signals X(1) to X(16) and one of the 16 second address signals Y(1) to Y(16), and thus determines whether to enable the corresponding scan signal or not. Each output buffer circuit receives and buffers the scan signal transferred from one of the 256 decoding circuits and then outputs the buffered scan signal.

In the example of FIG. 5, the decoding circuit 341 receives the first address signal X(1) and the second address signal Y(1). When the first address signal X(1) and the second address signal Y(1) are enabled during the first clock period T(1), the decoding circuit 341 enables the scan signal G(1). The output buffer circuit 351 buffers and outputs the enabled scan signal G(1). After the first clock period T(1) ends, the first address signal X(1) and the second address signal Y(1) are not enabled simultaneously, and the decoding circuit 341 disables the scan signal G(1). The other decoding circuits and the other output buffer circuits are the same as those mentioned hereinabove, so detailed descriptions thereof will be omitted.

In the scan driver according to the embodiment of the invention, the decoder and the output buffer unit include 256 decoding circuits. Each decoding circuit only needs four transistors, and the dimensional ratios between the transistors of the decoding circuit need not to be considered. So, the area occupied by the decoding circuit is very small.

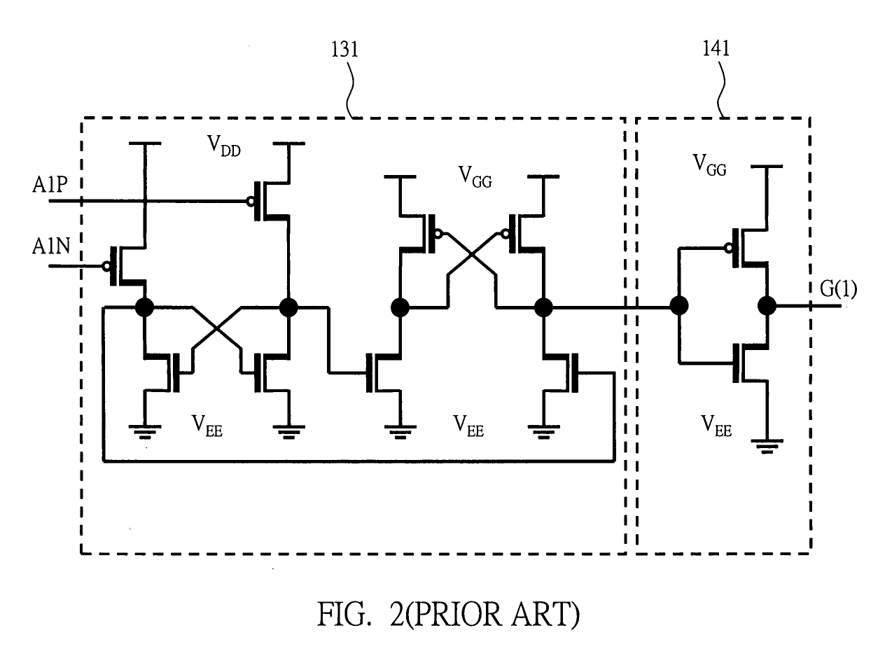

In addition, the scan driver according to this embodiment of the invention only outputs 16 first address signals and 16 second address signals. So, the level shifters 331 and 332 only need 16 level shift circuits, and the 16 first address signals and the 16 second address signals respectively corresponding thereto. The level shift circuit is the same as the level shift circuit 131 of FIG. 2. Compared with the conventional scan driver, in which 256 level shift circuits are used, the scan driver according to this embodiment of the invention only needs 32 level shift circuits. Thus, compared with the conventional scan driver, the scan driver according to the embodiment of the invention can achieve the effect of effectively saving the circuit area under the precondition of outputting the same number of scan signals.

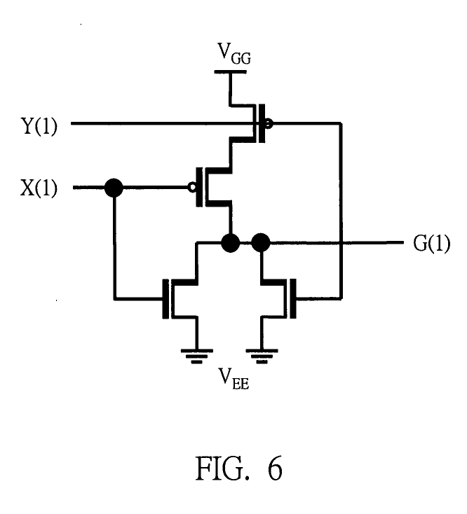

The decoder 340 may also use a different decoding circuit to achieve the same effect. FIG. 6 is a circuit diagram showing another NOR decoding circuit. In the example of FIG. 6, the decoding circuit receives the first address signal X(1) and the second address signal Y(1) and outputs the scan signal G(1).

In the scan driver according to the embodiment of the invention, for example, the first address logic circuit and the second address logic circuit respectively output 16 first address signals and 16 second address signals, and the decoder outputs 256 scan signals. In practice, the first and second address logic circuits may be configured to output different numbers of first and second address signals so that the decoder can output different numbers of scan signals.

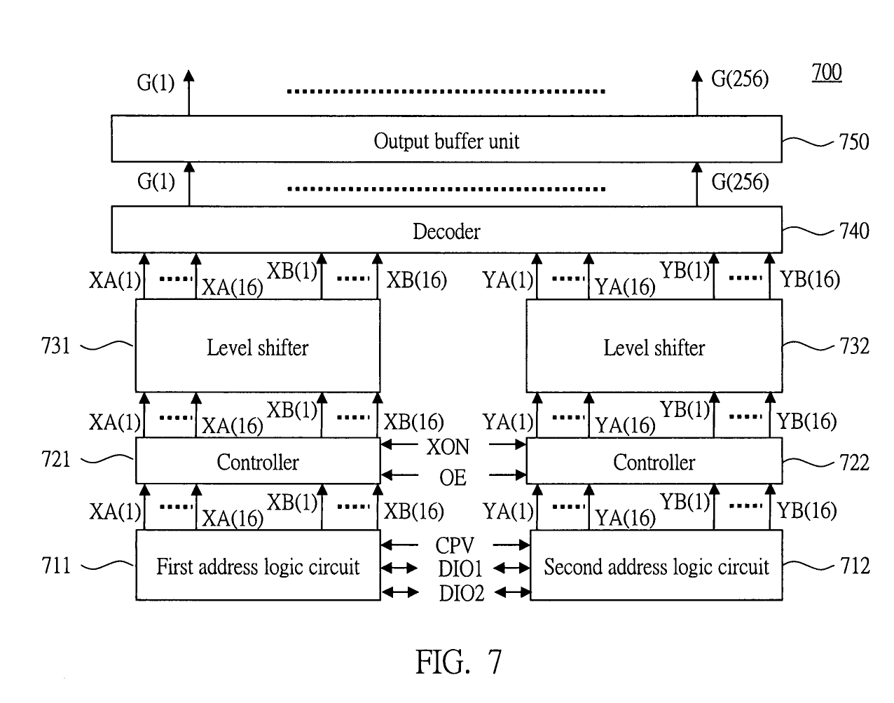

FIG. 7 shows a scan driver 700 according to another embodiment of the invention. As shown in FIG. 7, a first address logic circuit 711 of the scan driver 700 enables first address signals XA(1) to XA(16) and third address signals XB(1) to XB(16) according to two control signals DIO1 and DIO2, respectively. A second address logic circuit 712 of the scan driver 700 enables second address signals YA(1) to YA(16) and fourth address signals YB(1) to YB(16) according to the control signals DIO1 and DIO2, respectively.

The control signals DIO1 and DIO2 respectively and independently control the first and second address logic circuits 711 and 712. When the control signal DIO1 becomes enabled, the first address logic circuit 711 and the second address logic circuit 712 firstly enable the first address signal XA(1) and the second address signal YA(1). Then, a decoder 740 enables a scan signal G(1) in a manner the same as that mentioned hereinabove. As mentioned hereinabove, the first address logic circuit 711 sequentially and repeatedly enables the first address signals XA(1) to XA(16). The second address logic circuit 712 sequentially enables the second address signals YA(1) to YA(16). The decoder 740 sequentially enables the scan signals G(1) to G(256).

When the control signal DIO2 becomes enabled, the first address logic circuit 711 and the second address logic circuit 712 firstly enable the third address signal XB(1) and the fourth address signal YB(1). The decoder 740 enables the scan signal G(1) in a manner the same as that mentioned hereinabove. As mentioned hereinabove, the first address logic circuit 711 sequentially and repeatedly enables the third address signals XB(1) to XB(16). The second address logic circuit 712 sequentially enables the fourth address signals YB(1) to YB(16). The decoder 740 sequentially enables the scan signals G(1) to G(256).

The times when the control signals DIO1 and DIO2 become enabled may have a difference of several clock periods. In the following example, the control signal DIO1 becomes enabled earlier than the control signal DIO2. The control signal DIO2 becomes enabled during an A^{th} clock period T(A), wherein A is a positive integer. Consequently, the first address logic unit 711 enables the first address signal XA(A) and the third address signal XB(1), while the second address logic unit 712 enables the second address signal YA(A) and the fourth address signal YB(1) during the A^{th} clock period T(A). The decoder 740 correspondingly enables the scan signals G(A) and G(1). The scan signals have a difference of (A−1) clock periods.

During an (A+B)^{th} clock period, the first address logic unit 711 further enables a g^{th} third address signal XB(g) among 16 third address signals according to the control signal DIO2, wherein g is equal to a remainder of B/16 plus 1.

The second address logic unit 712 further enables a y^{th} fourth address signal YB(h) among 16 fourth address signals during the (A+B)^{th} clock period according to the second control signal DIO2, wherein h is equal to a quotient of B/16 plus 1.

When the g^{th} first address signal and the h^{th} second address signal are enabled, the decoder 740 further enables a ((h−1)×16+g)^{th} scan signal among 256 scan signals.

For example, the first control signal DIO1 becomes enabled earlier than the second control signal DIO2. During the fifth clock period, the second control signal DIO2 becomes enabled. At this time, the first address logic circuit 711 enables the first address signal XA(5) and the third address signal XB(1). The second address logic circuit 712 enables the second address signal YA(1) and the fourth address signal YB(1). The decoder 740 accordingly enables the scan signals G(5) and G(1).

Thereafter, during the 8^{th} clock period (i.e., the (5+3)^{th} clock period), for example, the first address logic unit 711 enables the first address signal XA(8) and the third address signal XB(4). The second address logic unit 712 enables the second address signal YA(1) and the fourth address signal YB(1). The decoder 740 accordingly enables the scan signals G(8) and G(4). The operations of the scan driver 700 during the other clock periods are the same as those mentioned herein, so detailed descriptions thereof will be omitted.

In the above-mentioned embodiment, for example, the control signal DIO1 becomes enabled earlier than the control signal DIO2. In practice, the control signal DIO2 may also become enabled earlier than the control signal DIO1. The control signal DIO1 and the control signal DIO2 may also be enabled simultaneously.

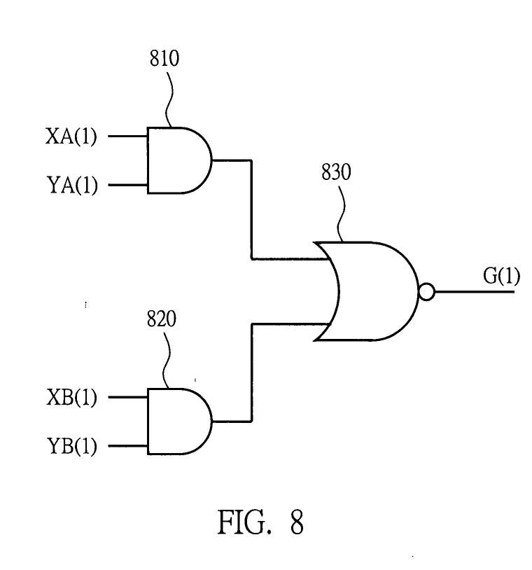

FIG. 8 shows the architecture of a decoding circuit 741 in the decoder 740 of the scan driver 700. Referring to FIG. 8, the decoding circuit 741 includes AND gates 810 and 820 and a NOR gate 830. In this embodiment of the invention, the decoder 740 has 256 decoding circuits. Each decoding circuit receives one of the first address signals XA(1) to XA(16), one of the second address signals YA(1) to YA(16), one of the third address signals XB(1) to XB(16) and one of the fourth address signals YB(1) to YB(16), and thus determines whether to enable the corresponding scan signal or not.

In the example of FIG. 8, the decoding circuit 741 receives the first address signal XA(1), the second address signal YA(1), the third address signal XB(1) and the fourth address signal YB(1). When the first address signal XA(1) and the second address signal YA(1) are enabled or when the third address signal XB(1) and the fourth address signal YB(1) are enabled, the decoding circuit 741 enables the scan signal G(1).

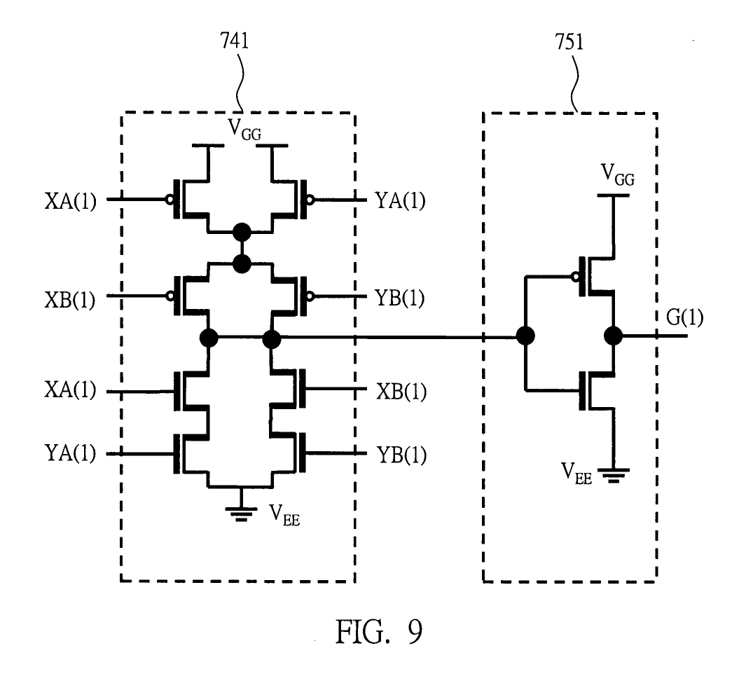

FIG. 9 is a circuit diagram showing a buffer circuit 751 in a buffer unit 750 of FIG. 7 and the decoding circuit of FIG. 8. The buffer unit 750 includes 256 buffer circuits. Each output buffer circuit receives and buffers the scan signals transferred from the 256 decoding circuits.

In the scan driver according to this embodiment of the invention, for example, the first address logic circuit outputs 16 first address signals and 16 third address signals, the second address logic circuit outputs 16 second address signals and 16 fourth address signals, and the decoder outputs 256 scan signals. In practice, the first and second address logic circuits may output different numbers of first, second, third and fourth address signals so that the decoder can output different numbers of scan signals.

The scan driver according to the embodiment of the invention enables one of several scan signals according to an enabled first address signal among several first address signals and an enabled second address signal among several second address signals. Compared with the conventional scan driver, the scan driver according to this embodiment of the invention only uses the fewer level shift circuits, and the decoding circuit occupying the smaller area. Thus, the scan driver according to the embodiment of the invention may further effectively save the circuit area and reduce the manufacturing cost.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scan driver for a liquid crystal display (LCD), the scan driver comprising:
a first address logic unit for enabling an i^{th} first address signal among N first address signals during a K^{th} clock period according to a first control signal, wherein the number i is equal to a remainder of K/N and is equal to N when K is a multiple of N;
a second address logic unit for enabling a j^{th} second address signal among M second address signals according to the first control signal during the K^{th} clock period, wherein the number j is equal to a quotient of K/N plus 1;
a first level shifter for increasing swings of the first address signals;
a second level shifter for increasing swings of the second address signals; and
a decoder for enabling a (j−1)×N+i)^{th} scan signal among M×N scan signals when the i^{th} first address signal is enabled and the j^{th} second address signal is enabled,
wherein each of the numbers K, M and N is a positive integer, the number i is a positive integer smaller than or equal to N, and the number j is a positive integer smaller than or equal to M.

2. The scan driver according to claim 1, wherein when the i^{th} first address signal and the j^{th} second address signal are enabled during the K^{th} clock period, the decoder enables the (j−1)×N+i)^{th} scan signal, which is a K^{th} scan signal of the M×N scan signals.

3. The scan driver according to claim 1, wherein the decoder comprises M×N decoding circuits each receiving one of the N first address signals and one of the M second address signals, and when one of the N first address signals and one of the M second address signals are enabled, the corresponding decoding circuit enables the corresponding scan signal.

4. The scan driver according to claim 1, wherein the scan driver further comprises an output buffer unit for buffering the M×N scan signals and thus outputting M×N buffered scan signals.

5. The scan driver according to claim 1, further comprising:
a first controller for receiving the N first address signals transferred from the first address logic unit, and determining whether to enable the N first address signals or not according to the first control signal; and
a second controller for receiving the M second address signals transferred from the second address logic unit and determining whether to enable the N second address signals or not according to a second control signal.

6. The scan driver according to claim 1, wherein the first control signal is a initial signal, and when the initial signal becomes enabled, the first and second address signals respectively enable a 1^{st} first address signal among the N first address signals and a 1^{st} second address signal among the M second address signals.

7. The scan driver according to claim 1, wherein the first address logic unit further enables a 1^{st} third address signal among N third address signals during an Ah clock period according to a second control signal;
wherein the second address logic unit further enables a 1^{st} fourth address signal among M fourth address signals during the A^{th} clock period according to the second control signal, wherein A is a positive integer.

8. The scan driver according to claim 7, wherein the first address logic unit further enables an X^{th} third address signal among N third address signals according to the second control signal during an (A+B)^{th} clock period;
wherein the second address logic unit further enables a y^{th} fourth address signal among M fourth address signals during the (A+B)^{th} clock period according to the second control signal;
x is equal to a remainder of B/N plus 1; and
y is equal to a quotient of B/N plus 1.

9. The scan driver according to claim 8, wherein when the x^{th} first address signal and the V^{th} second address signal are enabled, the decoder further enables a ((y−1)×N+x)^{th} scan signal among the M×N scan signals.
